(19) United States
(12) Patent Application Publication
(10) Pub. No.: US 2026/0350152 A1
(43) Pub. Date: Nov. 5, 2026

(54) SYSTEM AND METHOD FOR IDENTIFYING AND MITIGATING PARTICULAR CATEGORIES OF COMMUNICATIONS

(71) Applicant: Google LLC, Mountain View, CA (US)

(72) Inventors: Lokesh Singh, New Delhi (IN); Pranay Kumar Lohia, Bengaluru (IN); Vivek Dani, Mumbai (IN); Nirmal Kumar Gopalakrishnan, Chennai (IN); Vishwajeet Rana, BENGALURU (IN); Shaifali Bhandari, Bengaluru (IN); Steven Kester Yuwono, Cleminti (SG); Aruna Rajan, Bangalore (IN)

(21) Appl. No.: 19/198,256

(22) Filed: May 5, 2025

(51) Int. Cl. G06F 21/55; G06F 40/35

(52) U.S. Cl. CPC G06F 21/554; G06F 40/35; G06F 2221/034

(57) ABSTRACT

The systems and methodology described herein provide a technical benefit of allowing for robust real-time detection of communications of a particular category while still maintaining user privacy. In this regard, since the determination is fully conducted on a user's device, there is minimal delay in detection. Moreover, data collected during detection need not be saved locally in a memory device or exported externally, allowing for the maintenance of user privacy. Additionally, the real-time detection of a communication of the particular category itself allows mitigation of harm caused thereby.

### BACKGROUND

The complexity and prevalence of frauds and other malicious schemes that seek to exploit user's mobile phones and other personal communication devices is increasing dramatically. Current approaches to addressing such situations, largely reliant on reactive measures and post-event analysis, often fail to protect users. Moreover, existing solutions often lack the capacity to monitor and analyze real-time communication across multiple platforms, including emerging channels such as wearable devices and in-person interactions. Moreover, effectively intercepting certain types of activities occurring through both direct and indirect communication channels and providing timely assistance to victims remain significant challenges.

### BRIEF SUMMARY

The growing complexity and prevalence of frauds and other malicious schemes that seek to exploit user's mobile phones and other personal communication devices warrant a comprehensive solution that can detect and mitigate certain types of communications in real-time across diverse mobile communication channels. Communications of a particular category may intend to mislead a user of one or more user devices (e.g., mobile phone, tablet, PC, smartwatch, etc.). The misleading may be a scheme or fraud on the user for financial gain or to obtain information about that user or other people (e.g., gain money, sensitive personal information, etc.). As discussed herein, the systems include user device(s) that can proactively detect such categories of communications by, e.g., continuously analyzing text and/or audio data from one or more of a variety of sources, including, but not limited to, voice calls, SMS/messaging apps and/or wearable device audio streams, etc. The system is able to leverage trained machine learning models to identify fraudulent patterns and behaviors in real-time, enabling immediate alerts and procedural guidance in order to mitigate the impact of a scam.

Aspects of the technology are directed towards a method comprising detecting, by one or more processors of a user device, a communication associated with a user of the user device; identifying, by the one or more processors of the user device, contextual information of the communication; determining, by the one or more processors of the user device using a trained machine learning (ML) model stored on the user device, a likelihood value indicative of whether the communication is a communication of a particular category, wherein communications of the particular category are intended to mislead the user of the user device; classifying, by the one or more processors of the user device using the trained ML model, based on a comparison of the likelihood value to a threshold value, the communication as either the communication of the particular category or a communication not of the particular category, wherein the classifying is based at least in part on the contextual information; and upon classification of the communication as the communication of the particular category, generating, by the one or more processors of the user device, an alert to inform the user that the communication is the communication of the particular category.

In one example, the determining of the likelihood value is based on the contextual information. In another example, the method further includes modifying the threshold value based on the contextual information. Additionally, the modifying may include increasing the threshold value when the contextual information is not indicative of the particular category. Additionally or alternatively, the modifying may include decreasing the threshold value when the contextual information is indicative of the particular category.

In a further example, the communication is a telephonic communication. In an additional example, the contextual information includes a user action during or immediately following the communication. In another example, the trained ML model is trained, validated, and tested using at least one of i) real-life data, or ii) synthetic generated data.

In an additional example, the method further includes transcribing, by the one or more processors using an automatic speech recognition (ASR) model, the communication; and dividing, by the one or more processors, the transcribed communication in one or more portioning of a predetermined length for analysis by the trained ML model. In a further example, the alert includes guidance to the user to prevent loss due to the communication of the particular category.

In another example, the method further includes, upon classification of the communication as the communication of the particular category and in addition to generating the alert, controlling the user device to perform an action, the action being determined based on at least one of i) the communication and ii) a user action performed during or after the communication.

Another aspect of the technology is directed towards a method comprising receiving, at one or more processors of a second user device, a first classification of a communication associated with a user of a first user device and the second user device as either a communication of a particular category or not a communication of the particular category from the first user device, wherein the first classification is based on a first trained machine learning (ML) model and wherein the second user device is in communication with the first user device via a communication link; upon receipt of classification of the communication as the communication of the particular category, identifying, by the one or more processors of the second user device, contextual information of the communication; determining, by the one or more processors of the second user device using a second trained ML model stored on the second user device, a likelihood value indicative of whether the communication is the communication of the particular category, wherein communications of the particular category are intended to mislead a user of the second user device; classifying, by the one or more processors of the second user device using the second trained ML model, based on a comparison of the likelihood value to a threshold value, the communication as either the communication of the particular category or not a communication of the particular category, wherein the classifying is based on at least in part the contextual information; and upon classification of the communication as the communication of the particular category by the second trained ML model, generating, by the one or more processors of the second user device, an alert to inform the user that the communication is the communication of the particular category.

In one example, the determining of the likelihood value is based on the contextual information.

Another aspect of the technology is directed towards a user device comprising a memory including a trained machine learning (ML) model stored therein; and one or more processors operatively connected to the memory, the one or more processors configured to detect a communication associated with a use of the user device; identify contextual information of the communication; determine, using the trained ML model, a likelihood value indicative of whether the communication is a communication of a particular category, wherein communications of the particular category are intended to mislead a user of the user device; classify, using the trained ML model, based on a comparison of the likelihood value to a threshold value, the communication as either the communication of the particular category or a communication not of the particular category, wherein the classification is based at least in part on the contextual information; and upon classification of the communication as the communication of the particular category, generate an alert to inform the user that the communication is the communication of the particular category. In one example, the user device is a mobile device. In another example, the user device is a wearable device.

Another aspect of the technology is directed towards a user device comprising a memory including a second trained machine learning (ML) model stored therein; and one or more processors operatively connected to the memory, the one or more processors configured to receive a first classification of a communication associated with a user of the user device and a remote user device as either a communication of a particular category or a communication not of the particular category from the remote user device, wherein the first classification is based on a first trained ML model and wherein the remote user device is in communication with the user device via a communication link; upon receipt of classification of the communication as the communication of the particular category, identify contextual information of the communication; determine, using the second trained ML model, a likelihood value indicative of whether the communication is the communication of the particular category, wherein communications of the particular category are intended to mislead a user of the user device; classify, using the second trained ML model, based on a comparison of the likelihood value to a threshold value, the communication as either the communication of the particular category or the communication not of the particular category, wherein the classification is based at least in part on the contextual information; and upon classification of the communication as the communication of the particular category by the second trained ML model, generate an alert to inform the user that the communication is the communication of the particular category. In one example, the user device is a mobile device.

Another aspect of the technology is directed towards a non-transitory computer-readable recording medium having instructions stored thereon, the instructions, when executed by one or more processors of a user device, implement the method comprising detecting, by one or more processors of a user device, a communication associated with a user of the user device; identifying, by the one or more processors of the user device, contextual information of the communication; determining, by the one or more processors of the user device using a trained machine learning (ML) model stored on the user device, a likelihood value indicative of whether the communication is a communication of a particular category, wherein communications of the particular category are intended to mislead the user of the user device; classifying, by the one or more processors of the user device using the trained ML model, based on a comparison of the likelihood value to a threshold value, the communication as either the communication of the particular category or a communication not of the particular category, wherein the classifying is based at least in part on the contextual information; and upon classification of the communication as the communication of the particular category, generating, by the one or more processors of the user device, an alert to inform the user that the communication is the communication of the particular category.

Another aspect of the technology is directed towards a non-transitory computer-readable recording medium having instructions stored thereon, the instructions, when executed by one or more processors of a user device, implement the method comprising receiving, at one or more processors of a second user device, a first classification of a communication associated with a user of a first user device and the second user device as either a communication of a particular category or not a communication of the particular category from the first user device, wherein the first classification is based on a first trained machine learning (ML) model and wherein the second user device is in communication with the first user device via a communication link; upon receipt of classification of the communication as the communication of the particular category, identifying, by the one or more processors of the second user device, contextual information of the communication; determining, by the one or more processors of the second user device using a second trained ML model stored on the second user device, a likelihood value indicative of whether the communication is the communication of the particular category, wherein communications of the particular category are intended to mislead a user of the second user device; classifying, by the one or more processors of the second user device using the second trained ML model, based on a comparison of the likelihood value to a threshold value, the communication as either the communication of the particular category or not a communication of the particular category, wherein the classifying is based on at least in part the contextual information; and upon classification of the communication as the communication of the particular category by the second trained ML model, generating, by the one or more processors of the second user device, an alert to inform the user that the communication is the communication of the particular category.

### BRIEF DESCRIPTION OF DRAWINGS

FIG. 1 illustrates an example system flow 100 in accordance with aspects of the disclosure.

FIG. 2 illustrates an example system flow 200 in accordance with aspects of the disclosure.

FIG. 3 illustrates an example flow of a training data generation module in accordance with aspects of the disclosure.

FIG. 4 illustrates an example client computing device in accordance with aspects of the disclosure.

FIG. 5 illustrates a block diagram of an example client computing device in accordance with aspects of the disclosure.

FIG. 6 illustrates an example client computing device in accordance with aspects of the disclosure.

FIG. 7 illustrates a block diagram of an example client computing device in accordance with aspects of the disclosure.

FIG. 8 illustrates an example client computing device in accordance with aspects of the disclosure.

FIG. 9 illustrates a block diagram of an example client computing device in accordance with aspects of the disclosure.

FIG. 10A is a pictorial diagram of an example network in accordance with aspects of the disclosure.

FIG. 10B is a functional diagram of the example network in FIG. 7A in accordance with aspects of the disclosure.

FIG. 11 illustrates a system for use with aspects of the technology in accordance with aspects of the disclosure.

FIG. 12 illustrates an example method in accordance with aspects of the technology.

FIG. 13 illustrates an example method in accordance with aspects of the technology.

### DETAILED DESCRIPTION

### Overview

The systems and methodology described herein provide a technical benefit of allowing for robust real-time detection of communications of a particular category while still maintaining user privacy. In this regard, since the determination is fully conducted on a user's device, there is minimal delay in detection. Moreover, data collected during detection need not be saved locally in a memory device or exported externally, allowing for the maintenance of user privacy. Additionally, the real-time detection of a communication of the particular category itself allows mitigation of harm caused thereby.

### Example Systems

Unless otherwise stated, the disclosed examples and scenarios are not mutually exclusive, but may be implemented in various combinations to achieve unique advantages. As these and other variations and combinations of the features discussed above can be utilized without departing from the subject matter defined by the claims, the description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

### System Overview

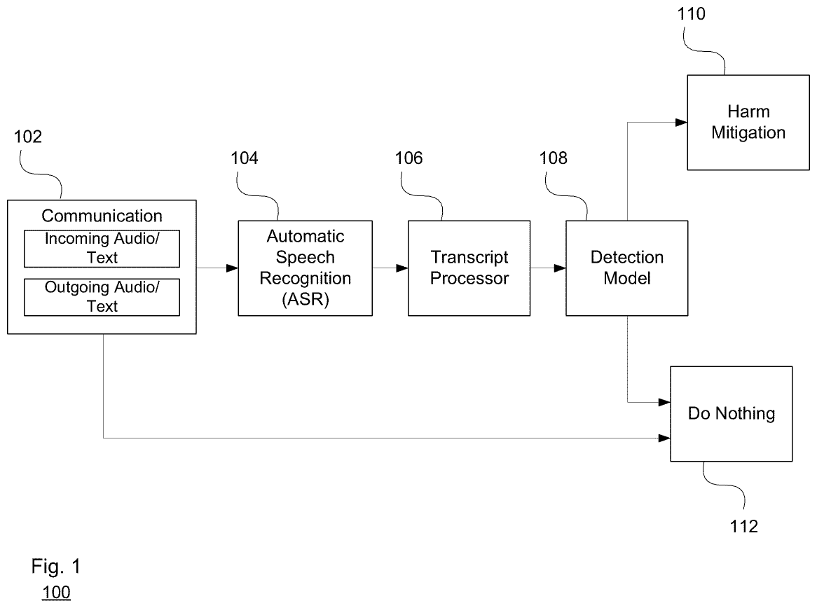

As discussed above, a user device may be used in a system for detection of a malicious communication of a particular category (e.g., scam detection). FIG. 1 illustrates an example system flow 100 used by a system for detection of a communication of a particular category. The system may be implemented using one or more processors of a device implementing the system, e.g., client mobile device 402, client mobile device 500, wearable client device 602, wearable client device 700, client computing device 802, client computing device 900.

FIG. 1 shows an example system flow 100 used by a system for detection of a communication (e.g., phone call, videoconference, email, text messaging services, etc.) of a particular category. At block 102, the system flow 100 includes initiation of a communication. The communication may include incoming audio, outgoing audio, incoming text, outgoing text or some combination thereof. The incoming text and/or outgoing text may include a plurality of text communications (e.g., an email chain, a text or instant message chain, or the like). The incoming audio and/or incoming text may be associated with a user of a remote device. The outgoing audio and/or outgoing text may be associated with a user of the user device (e.g., client mobile device 402, client mobile device 500, wearable client device 602, wearable client device 700, client computing device 802, client computing device 900). The communication may be detected by one or more processors of the user device. In this regard, the one or more processors may be configured to detect when a communication is received or initiated by the user device. In some instances, the communication may be an in-person communication. In some instances, the user may provide one or more permissions allowing the system to detect the communication.

In some instances, no further action may be taken by the one or more processors if the communication is associated with a known contact (e.g., the remote device is associated with a saved contact in a contact list associated with the user). In this regard, the flow 100 may proceed to block 112 and the one or more processors may do nothing. In such an instance, no further action may be taken as a communication associated with a known contact is unlikely to be a communication of a particular category such as, for example, a scam communication. In this regard, scam communications generally originate from unknown devices. Additionally or alternatively, the one or more processors may take no further action if the communication is associated with a known contact that has been contacted a number of times (e.g., contacted five times or more or less). In such an instance, no further action may be taken as a communication associated with a known contact that is repeatedly contacted is unlikely to be a scam communication. Additionally or alternatively, the one or more processors may take no further action if the communication is associated with a known contact that has been contacted a number of times (e.g., contacted five times or more or less) within a predetermined period of time (e.g., in the last 30 days or more or less). In such an instance, no further action may be taken as a communication associated with a known contact that is repeatedly contacted in a recent time frame is unlikely to be a scam communication. Additionally or alternatively, the one or more processors may take no further action if the communication is associated with a known contact that became known to the user prior to a predetermined period of time (e.g., the remote device has been associated with a saved contact for at least 30 days or more or less). In such an instance, no further action may be taken as a communication associated with a known contact that has been known to the user for a predetermined period of time is unlikely to be a scam communication.

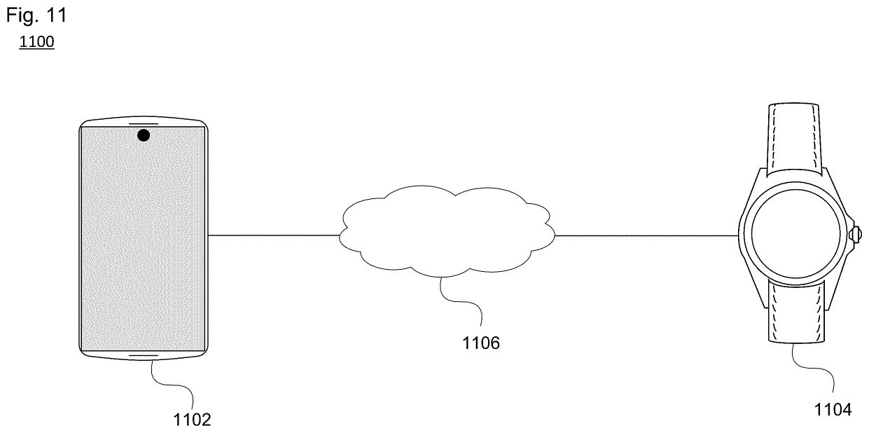

The one or more processors may record or otherwise monitor the communication. When a communication includes audio, the recording may include use of one or more sensors to record or temporarily capture the audio. The one or more sensors may be one or more sensors of the user device. The one or more sensors may include a microphone (e.g., microphone 406, microphone 530, microphone 606, microphone 730, microphone 930). In some instances, the one or more sensors may include sensors of a second user device. The second user device may be configured to communicate with the user device as shown in, for example, FIG. 11. In some instances, the one or more processors may be configured to provide a notification to one or more parties participating in the communication that the communication is being recorded. Additionally or alternatively, the user device may activate indicator (e.g., indicator 410, 816) or provide a notification to a user of the user device when the device is recording audio. Such a notification and/or activation of an indicator may be advantageous in an instance where the communication includes audio to address privacy considerations. When a communication includes text, the one or more processors may be configured to record or capture the text of the communication. The one or more processors may use one or more features of the operating system of the device to capture the text of the communication. For example, the recording may include a screen capture of the text of the communication.

At block 104, the system flow 100 includes implementation of an automatic speech recognition (ASR) model. In this regard, upon the receipt of the record of the communication that includes audio from the one or more processors, the one or more processors may implement the ASR model. The ASR model may be configured to transcribe the recorded communication (e.g., recorded audio and) into a format usable by a transcript processor at block 106. In some instances, the ASR model may include translation capabilities. In this regard, the system may be configured to analyze communications in a predetermined language (e.g., English). In such an instance, the scam ASR model may translate the transcribed audio into the predetermined language for further analysis.

At block 106, the system flow 100 includes implementation of the transcript processor. In this regard the one or more processors may implement a transcript processor on transcribed audio and/or text of the communication. The transcript processor may be configured to “chunk” transcripts including the audio and/or text of the communication into discrete portions. For example, the chunking may include dividing the transcript into N portions of similar size. The portions or chucks may be a predetermined length capable of being analyzed by a detection model at block 108. In some instances, the chunks may be a number of words (e.g., 100, 200, 300, or more or less). Additionally or alternatively, the chunks may be a number of sentences (e.g., 1 sentence, 2 sentences, etc.). Alternatively, the recorded communication may be chunked prior to transcription by the ASR model.

At block 108, the system flow 100 includes implementation of a detection model configured to detect a communication of a particular category. The particular category may include, for example, scam communications. In this regard, the detection model may be a scam detection model. After processing the transcript at the transcript processor, the one or more processors may use the detection model to analyze the processed transcript. The detection model may be a machine learning (ML) model stored and executed entirely on the user device. The ML model may be a natural language processing (NPL) model. In some instances, the ML may be a Gaussian mixture model (GMM) based model, a long short-term memory (LSTM) based model, or some combination thereof. In some instances, the ML model may not be a large language model (LLM).

The ML model may be configured to output a binary classification indicative of if the communication is of the particular category based on an analysis of the processed transcript. Based on the analysis, the ML model may determine a likelihood regarding whether or not the communication is a communication of the particular category. If the likelihood is above a threshold value, the ML model may output a result indicating the communication is of the particular category. If the likelihood is below the threshold value, the ML model may output a normal result. The normal result meaning the communication is not of the particular category.

In instances where the detection model is a scam detection model and the particular category includes scam communications, a type of scam may be determined based on detection of certain words. For example, a scam targeting personal data may be detected by the presence of personal data related terms (e.g., name, address, SSN, etc.). In another example, a scam targeting finances may be detected based on the presence of finance related terms (e.g., money, dollars, credit card etc.).

Additionally, the ML model may further base the output result on context information associated with the communication. The contextual information may be identified by the one or more processors of the user device. In some instances, the one or more processors may utilize one or more sensors of the user device to identify contextual information. In some instances, the context may be analyzed by the ML model resulting in an increase or decrease of the likelihood value. Additionally or alternatively, the context may increase or decrease the threshold value to which the likelihood value is compared.

In instances where the detection model is a scam detection model and the particular category includes scam communications, the contextual information may be indicative of behavior patterns of scammers and/or victims. In this regard, the context may include information such as one or any combination of environmental information of the remote device and the client device (e.g., location, ambient noise), opening of an application (e.g., banking application) during or immediately after (e.g., within 1 minute, 10 minutes, or more or less) the communication, screen sharing of the user device during the communication, installing a new application to the user device during or immediately after the communication, allowing for remote control of the user device during the communication, knowledge base of known contacts (e.g., whether the remote device is associated with a saved contact or is an unknown), physiological signals of the user of the user device (e.g., heart rate, skin conductance). In some instances, the user may provide one or more permissions allowing the system to collect or not collect certain forms of contextual information. In some examples, the contextual information may include a knowledge base of identifiers associated with known or suspected scammers. Such a knowledge base may be downloaded onto the device or may be collected by the device over time (e.g. based on previously analyzed communications). In some examples, the device may store identifiers of entities whose communications have been categorized as a scam. In addition or alternatively, the device may store identifiers of entities whose communications were not categorized as a scam (e.g. for which the likelihood value was not above the threshold), but for which the likelihood value was above a lower threshold. In such examples, the stored identifiers of these ‘suspicious entities’ may then be used in future for lowering the threshold for determining a scam result. As such, if another communication with an entity whose identifier is stored (a suspicious entity) occurs, the device may be more sensitive to a possible scam and so more likely to output a scam result.

In some instances, a combination of context information may be analyzed in the increase or decrease of the likelihood and/or increase or decrease of the threshold value. In instances where the detection model is a scam detection model and the particular category includes scam communications, certain combinations of contextual information may be indicative of a high probability of a scam and thus be given more weight than when observed in combination. For example, if a user of the user device both downloads an application during the communication and screenshares during the communication, such behavior is highly indicative of a scam and should be given more weight.

In some instances, the context may be identified or collected both by the user device and a second user device. In this regard, the contextual information may be additionally identified by the one or more processors of the second user device. The one or more processors of the second user device may utilize one or more sensors thereof to identify contextual information. For example, if the user device is a client mobile device (e.g., client mobile device 402, 500) and the second user device is a wearable client device (e.g., wearable client device 602, 700), the second user device may provide context such as environmental information, physiological signals, etc. to the one or more processors of the user device.

The ML model may be stored on the user device without occupying a majority of the memory of the device. For example, the ML model may be 25 MB or more or less. In this regard, the ML model may allow for scam detection functionality on a device without occupying the majority of the memory thereof. This may be especially advantageous when the device is a device with relatively smaller memory (e.g., client mobile device 402, 500, wearable client device 602, 700).

The ML model may be trained, as further discussed below, on one or more of real-life text/data/videos/audios, synthetic generated data by LLMs, and emergency related data (e.g., injury, life-threatening medical emergencies, fires, crimes in progress, and situations involving imminent danger), and high confidence data (e.g., high confidence scam and non-scam data).

As shown at block 110, if the detection model outputs a result indicating the communication is of the particular category, the one or more processors may initiate a set of harm mitigation strategies. In instances where the detection model is a scam detection model and the particular category includes scam communications, the harm mitigation strategies may include a set of scam mitigation strategies (e.g., one or more specific scam strategies). The harm mitigation strategies may include one or more of alerts to the user and/or third parties, providing guidance to the user to prevent loss, and initiating automatic control of the user device. Harm mitigation strategies may be carried out directly by the user device, without needing external input (e.g., server or other remote input).

The alerts to the user may include, visual, text, audio, and or haptic alerts to signal to the user that the communication is of the particular category. The alerts may be presented to the user by the user device. The alerts may also be a prompt asking a user if they want to take a particular action. For example, when the particular category includes scam communications, when a scam is detected and a user attempts to open a sensitive application (e.g., banking application). The prompt may display text such as, “Are you sure? Possible Scam.” Additionally or alternatively, the alerts may be presented to the user by a second user device, such as a wearable. The alerts to a third party may include a communication to, for example, a banking institution of the user reporting possible fraudulent activity and/or requesting an account freeze. In another example, the alerts to a third party may include sending a message (e.g., audio, text) to one or more emergency contacts of the user.

The guidance to the user to prevent loss may include suggestions for the user to protect themselves from loss (e.g., financial loss, loss of personal information). For example, the suggestions may include messages such as: “disconnect the internet and/or shut down your device;” “do not share credit card details;” “freeze once bank account, temporarily to avoid transfer of money to scammers account;” etc. In some instances, when the particular category includes scam communications, the guidance provided may be based on a type of detected scam. For example, if a scam targeting personal data is detected, the suggestions may include messages to mitigate personal data loss (e.g., “disconnect the internet and/or shut down your device”). In another example, if a scam targeting finances is detected, the suggestions may include messages to mitigate financial loss (e.g., “do not share credit card details;” “freeze once bank account, temporarily to avoid transfer of money to scammers account”).

The initiation of automatic control of the user device may allow the one or more processors to take action to prevent loss resulting from the communication. The automatic control may include one or more of ending the communication, uninstalling, disabling or blocking application(s) (e.g. those downloaded during the communication), and locking sensitive applications or information (e.g., banking or other account-related details, contact lists, etc.).

As shown at block 112, if the detection model outputs a normal result (e.g., the communication is not a communication of the particular category) the system does nothing in response to the communication.

In some instances, following the termination of the communication and/or the conclusion of the harm mitigation strategies, the one or more processors may not store or export any data related to the communication or detection. In this regard, the one or more processors may not store the recorded communication, the transcription of the recorded communication, the processed transcript, outputs or determinations of the detection model, or any information related to harm mitigation. The lack of storage or export may allow a user to retain privacy of communications associated with the user device. In this way, the system employed on the user device may allow for detection and mitigation without privacy concerns regarding any collected data.

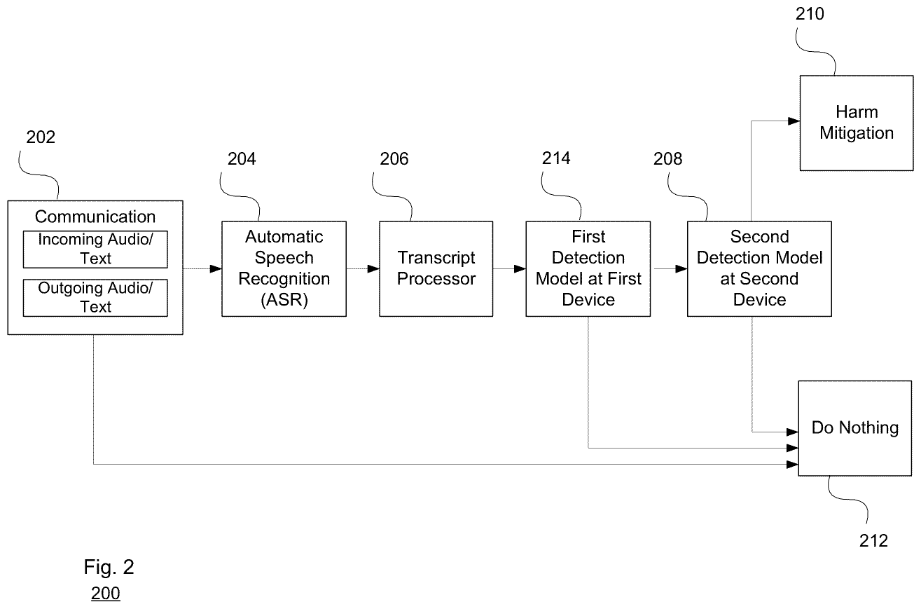

In some instances, the system for detection of the communication of the particular category may be implemented using a first user device and a second user device (or multiple additional user devices). In such an instance, the first user device may implement a detection model that is less robust than a detection model of the second user device and thus may function as a filter to determine if a determination is needed using the detection model of the second user device. Moreover, the first user device may provide additional contextual information (e.g., via a heart rate sensor, perspiration sensor, and/or other user-focused, device-focused, or environment-focused sensors). In this regard, FIG. 2 illustrates an example system flow 200 used by a system for detection of a communication of a particular category (e.g., scam detection). The system may be implemented using one or more processors of a first user device (e.g., wearable client device 602, wearable client device 700) and one or more processors of a second user device (e.g., client mobile device 402, client mobile device 500, client computing device 802, client computing device 900). The first user device and the second user device may communicate with one another as shown in, for example, FIG. 11.

FIG. 2 shows an example system flow 200 used by a system for detection of a communication (e.g., phone call, videoconference, email, text messaging services) of a particular category. At block 202, the system flow 200 includes initiation of a communication. The communication may include incoming audio, outgoing audio, incoming text, outgoing text or some combination thereof. The incoming audio and/or incoming text may be associated with a user of a remote device. The outgoing audio and/or outgoing text may be associated with a user of the first user. The communication may be detected by one or more processors of the first user device. In this regard, the one or more processors may be configured to detect when a communication is received or initiated by the first user device or the second user device. In some instances, the communication may be an in-person communication. In some instances, the user may provide one or more permissions allowing the system to detect the communication.

In some instances, no further action may be taken by the one or more processors of the first user device if the communication is associated with a known contact (e.g., the remote device is associated with a saved contact). In this regard, the flow 200 may proceed to block 212 and the one or more processors may do nothing. In such an instance, no further action may be taken as a communication associated with a known contact is unlikely to be a communication of a particular category such as, for example, a scam communication. In this regard, scam communications generally originate from unknown devices. Additionally or alternatively, the one or more processors of the first user device may take no further action if the communication is associated with a known contact that has been contacted a number of times (e.g., contacted five times or more or less). In such an instance, no further action may be taken as a communication associated with a known contact that is repeatedly contacted is unlikely to be a scam communication. Additionally or alternatively, the one or more processors of the first user device may take no further action if the communication is associated with a known contact that has been contacted a number of times (e.g., contacted five times or more or less) within a predetermined period of time (e.g., in the last 30 days or more or less). In such an instance, no further action may be taken as a communication associated with a known contact that is repeatedly contacted in a recent time frame is unlikely to be a scam communication. Additionally or alternatively, the one or more processors of the first user device may take no further action if the communication is associated with a known contact that became known to the user prior to a predetermined period of time (e.g., the remote device has been associated with a for at least 30 days or more or less). In such an instance, no further action may be taken as a communication associated with a known contact that has been known to the user for a predetermined period of time is unlikely to be a scam communication.

The one or more processors of the first user device may record the communication. When a communication includes audio, the recording may include use of one or more sensors to record the audio. The one or more sensors may be one or more sensors of the first user device and/or the second user device. The one or more sensors may include a microphone (e.g., microphone 406, microphone 530, microphone 606, microphone 730, microphone 930). In some instances, the one or more processors may be configured to provide a notification to one or more parties participating in the communication that the communication is being recorded. Additionally or alternatively, the first and/or second user device may activate indicator (e.g., indicator 410, 816) or provide a notification to a user when the device is recording audio. Such a notification and/or activation of an indicator may be advantageous in an instance where the communication includes audio to address privacy considerations. When a communication includes text, the one or more processors may be configured to record or capture the text of the communication. The one or more processors may use one or more features of the operating system of the device to capture the text of the communication. For example, the recording may include a screen capture of the text of the communication.

At block 204, the system flow 200 includes implementation of an ASR model. In this regard, upon the receipt of the record of the communication that includes audio from the one or more processors of the first client device, the one or more processors of the first client device may implement the ASR model. The ASR model may be configured to transcribe the recorded communication (e.g., recorded audio) into a format usable by a transcript processor at block 206. In some instances, the ASR model may include translation capabilities. In this regard, the system may be configured to analyze communications in a predetermined language (e.g., English). In such an instance, the scam ASR model may translate the transcribed audio into the predetermined language for further analysis.

At block 206, the system flow 200 includes implementation of the transcript processor. In this regard, the one or more processors of the first client device may implement the transcript processor on transcribed audio and/or text of the communication. The transcript processor may be configured to “chunk” transcripts including audio and/or text of the communication into discrete portions. For example, the chunking may include dividing the transcript into N portions of similar size. The portions or chucks may be a predetermined length capable of being analyzed by a first detection model at block 214 and in some instances, a second detection model at block 208. In some instances, the chunks may be a number of words (e.g., 100, 200, 300, or more or less). Additionally or alternatively, the chunks may be a number of sentences (e.g., 1 sentence, 2 sentences, etc.). Alternatively, the recorded communication may be chunked prior to transcription by the ASR model.

At block 214, the system flow 200 includes implementation of a first detection model configured to detect a communication of a particular category. The particular category may include, for example, scam communications. In this regard, the detection model may be a scam detection model. After processing the transcript at the transcript processor, the one or more processors of the first user device may use the first detection model to analyze the processed transcript. The first detection model may be a first ML model stored and executed entirely on the first user device. The first ML model may be a NPL model. In some instances, the first ML may be a GMM based model, a LSTM based model, or some combination thereof. In some instances, the first ML model may not be LLM.

The first ML model may be configured to output a binary classification indicative of if the communication is of the particular category based on an analysis of the processed transcript. Based on the analysis, the first ML model may determine a likelihood regarding whether or not the communication is a communication of the particular category. If the likelihood is above a threshold value, the first ML model may output a result indicating the communication is of the particular category. If the likelihood is below the threshold value, the first ML model may output a normal result. The normal result meaning the communication is not of the particular category.

As shown at block 212, if the first scam detection model outputs a normal result, the system does nothing in response to the communication. In this regard, the first detection model of the first user device may be less robust than the second detection model, shown at block 208, and thus may function as a ‘coarse’ filter to determine if a determination is needed using the second detection model. For instance, the first model may be configured such that it classifies more communications as related to the particular category than does the second model. As an example, the threshold employed by the first ML model may be lower than that utilized by the second ML model.

As shown in block 208, if the first detection model outputs a result indicating the communication is of the particular category, the processed transcript of communication may be analyzed by the second detection model via the one or more processors of the second user device. In this regard, the one or more processors of the second user device may use a second detection model to analyze the processed transcript. The second detection model may be a second ML model stored and executed entirely on the second user device. The second ML model may be an NLP model. In some instances, the second ML may be a GMM based model, a LSTM based model, or some combination thereof. In some instances, the second ML model may not be LLM.

Like the first ML model, the second ML model may be configured to output a binary classification indicative of if the communication is of the particular category based on an analysis of the processed transcript. Based on the analysis, the second ML model may determine a likelihood regarding whether or not the communication is a communication of the particular category. If the likelihood is above a threshold value, the second ML model may output a result indicating the communication is of the particular category. If the likelihood is below the threshold value, the second ML model may output a normal result. The normal result meaning the communication is not of the particular category. Additionally, the threshold value of the second ML model may be higher relative to the threshold value of the first ML model.

In instances where the detection model is a scam detection model and the particular category includes scam communications, a type of scam may be determined based on detection of certain words. For example, a scam targeting personal data may be detected by the presence of personal data related terms (e.g., name, address, SSN, etc.). In another example, a scam targeting finances may be detected based on the presence of finance related terms (e.g., money, dollars, credit card etc.). In some examples, the second user device (e.g. the second ML model), may be configured to distinguish between different scams, but the first user device may not be so configured. Thus, in some examples, the first model may be configured to determine whether or not a communication is a scam and the second ML model may have a higher threshold value and may additionally be able to identify a type of scam. In some examples, the second device may additionally be configured to determine a particular action to take based on the type of scam.

Additionally, the second ML model may further base the output result classification on context information associated with the communication. The contextual information may be identified by the one or more processors of the first and second user devices. In some instances, the one or more processors of the first and second user devices may utilize one or more sensors of the first and second user devices to identify contextual information. In some instances, the context may be analyzed by the second ML model resulting in an increase or decrease of the likelihood value. Additionally or alternatively, the context may increase or decrease the threshold value to which the likelihood value is compared.

In instances where the detection model is a scam detection model and the particular category includes scam communications, the contextual information may be indicative of behavior patterns of scammers and/or victims. In this regard, the context may include information such as one or any combination of environmental information of the remote device and the client device (e.g., location, ambient noise), opening of an application (e.g., banking application) during or immediately after (e.g., within 1 minute, 10 minutes, or more or less) the communication, screen sharing of the first or second user device during the communication, installing a new application to the first or second user device during or immediately after the communication, allowing for remote control of the first or second user device during the communication, knowledge base of known contacts (e.g., whether the remote device is associated with a saved contactor is an unknown), physiological signals of the user of the first or second user device (e.g., heart rate, skin conductance). The context may be collected both by the first user device and the second user device. In some instances, the user may provide one or more permissions allowing the system to collect or not collect certain forms of contextual information. In some examples, the contextual information may include a knowledge base of identifiers associated with known or suspected scammers. Such a knowledge base may be downloaded onto the device or may be collected by the device over time (e.g. based on previously analyzed communications). In some examples, the device may store identifiers of entities whose communications have been categorized as a scam. In addition or alternatively, the device may store identifiers of entities whose communications were not categorized as a scam (e.g. for which the likelihood value was not above the threshold), but for which the likelihood value was above a lower threshold. In such examples, the stored identifiers of these ‘suspicious entities’ may then be used in future for lowering the threshold for determining a scam result. As such, if another communication with an entity whose identifier is stored (a suspicious entity) occurs, the device may be more sensitive to a possible scam and so more likely to output a scam result.

In some instances, a combination of context information may be analyzed in the increase or decrease of the likelihood and/or increase or decrease of the threshold value. In instances where the detection model is a scam detection model and the particular category includes scam communications, certain combinations of contextual information may be indicative of a high probability of a scam and thus be given more weight than when observed in combination. For example, if a user of the user device both downloads an application during the communication and screenshares during the communication, such behavior is highly indicative of a scam and should be given more weight.

In some examples in which the second user device and/or ML model takes context information into account when determining its scam or normal classification, the first user device and/or first ML model may not base its classification on such context information. In other examples, the first user device and/or ML model may utilize context information but the second user device and/or ML model may utilize different contextual information (e.g. which is not available to the first user device). In such examples, the different context information (‘second context information’) may be used by the second user device and/or second ML model in addition to the context information (‘first context information’) used by the first user device and/or first ML model. For instance, where the first contextual information was gathered by the first user device, it may be provided by the first user device to the second user device. In other examples, the first contextual information may not be utilized directly by the second user device/ML model. Instead, the likelihood value output by the first ML model, which was determined based on the first contextual information, may be taken into account by the second user device/ML model. Thus, the first contextual information may be taken into account indirectly by the second user device/ML model.

The first and second ML models may be stored on their respective user device without occupying a majority of the memory of the device. For example, the first and second ML models may each be 25 MB or more or less. In this regard, the ML model(s) may allow for scam detection functionality on a device without occupying the majority of the memory thereof. This may be especially advantageous when the device is a device with relatively smaller memory (e.g., client mobile device 402, 500, wearable client device 602, 700). In some examples, the second ML model, which may be more capable and/or accurate than the first ML model, may have a larger memory footprint than the first model.

The first and second ML models may be trained, as further discussed below, on one or more of real-life scam text/data/videos/audios, synthetic generated data by LLMs, emergency related data (e.g., injury, life-threatening medical emergencies, fires, crimes in progress, and situations involving imminent danger), and high confidence data (e.g., high confidence scam and non-scam data).

As shown at block 210, if the second detection model outputs a result indicating the communication is of the particular category, the one or more processors may initiate a set of harm mitigation strategies. In instances where the detection model is a scam detection model and the particular category includes scam communications, the harm mitigation strategies may include a set of scam mitigation strategies (e.g., one or more specific scam strategies). The harm mitigation strategies may include one or more of alerts to the user and/or third parties, providing guidance to the user to prevent loss, and initiating automatic control of the first and/or second user device. Harm mitigation strategies may be carried out directly by the first and/or second user device, without needing external input (e.g., server input).

The alerts to the user may include, visual, text, audio, and or haptic alerts to signal to the user that the communication is of the particular category. The alerts may be presented to the user by the first and/or second user device. The alerts may also be a prompt asking a user if they want to take a particular action. For example, when the particular category includes scam communications, when a scam is detected and a user attempts to open a sensitive application (e.g., banking application). The prompt may display text such as, “Are you sure? Possible Scam.” The alerts to a third party may include a communication to, for example, a banking institution of the user reporting possible fraudulent activity and/or requesting an account freeze. In another example, the alerts to a third party may include sending a message (e.g., audio, text) to one or more emergency contacts of the user.

The guidance to the user to prevent loss may include suggestions for the user to protect themselves from loss (e.g., financial loss, personal information loss). In some instances, when the particular category includes scam communications, the guidance provided may be based on a type of detected scam. For example, if a scam targeting personal data is detected, the suggestions may include messages to mitigate personal data loss (e.g., “disconnect the internet and/or shut down your device”). In another example, if a scam targeting finances is detected, the suggestions may include messages to mitigate financial loss (e.g., “do not share credit card details;” “freeze bank account temporarily to avoid transfer of money to scammers account”).

The initiation of automatic control of the first and/or second user device may allow the one or more processors of the first and/or second user device to take action to prevent loss resulting from the scam. The action to be performed via automatic control may be determined based on the communication and/or based on a user action performed using the user device during or after the communication. For example, the action to be performed via automatic control may include one or more of ending the communication, uninstalling, disabling or blocking application(s) (e.g. those downloaded during the communication), and locking sensitive applications or information (e.g., banking or other account-related details, contact lists, etc.).

As an example, when the particular category includes scam communications, if a communication identified as a scam includes text encouraging a user to perform an action via a particular application (e.g. a banking application), the automatic action may include temporarily locking the application or requiring additional steps/confirmations before the user can access the application. As another example, when the particular category includes scam communications, if a communication identified as a scam includes text encouraging a user to download an application during or after the call, the downloading of the application may be prevented or the application may be locked or disabled.

In other examples, the user may be prevented from taking certain actions in respect of an entity associated with a communication categorized as of the particular category. For instance, the user may be prevented from sending certain information to the entity. In some examples, the automatic control of the first and/or second user device may be initiated responsive to a confirmation from the user. For instance, the user device may provide a message indicating the action that it recommends (e.g. “you should end this call” or “It is recommended to delete this application”), and the action may be performed automatically responsive to user confirmation (e.g. via a touch input or a voice command). In other examples, no user confirmation may be required.

As shown at block 212, if the second detection model outputs a normal result the system does nothing in response to the communication.

In some instances, following the termination of the communication and/or the conclusion of the harm mitigation strategies, the one or more processors of the first user device and the second user device may not store or externally export any data related to the communication or detection. In this regard, the one or more processors of the first user device and the second user device may not store the recorded communication, the transcription of the recorded communication, the processed transcript, outputs or determinations of the first and second detection models, or any information related to harm mitigation. The lack of storage or external export may allow a user to retain privacy of communications associated with the first and second user devices. In this way, the system employed on the first and second user devices may allow for detection and mitigation without privacy concerns regarding any collected data. In some examples, when the system is a scam detection system, responsive to detecting a scam, an identifier associated with the scamming entity (e.g. a telephone number or the like) may be transmitted to a server for use in future scam detection. However, other details of the communication, such as the transcript or the like, may not be transmitted. Such transmission may be automatic or responsive to confirmation from the user.

In some instances, following a prediction made by a system for detection of a communication of a particular category such as those illustrated in FIGS. 1-2, a user may provide feedback to the system on whether the prediction made was correct or not. This feedback may be given back to the system to incrementally improve its prediction and understand new nuances on how such communications occur. The feedback may be collected by the system and used to update training data and the training of the ML models. In some instances, the feedback may be stored in a database of the system. Additionally or alternatively, in some instances, the feedback may be provided by a user via a “share feedback” option on a provided alert.

In the example described above with respect to FIG. 2, the second user device, and the second ML model, are utilized if the first ML model outputs a result indicative of the communication being of a particular category. However, in other examples, the second user device and the second ML model may be utilized in the event that the first model has a low confidence that the communication is of the particular category. For instance, when the confidence is above a first threshold, the first model may categorize the communication as of the particular category (e.g., a scam) and may output a harm mitigation strategy (e.g., an alert) (and the second user device may not be employed), but when the confidence is lower than the first threshold, but higher than a second threshold, the second user device and the second model may be utilized. If the confidence is below the second threshold, the first user device may simply do nothing and the second model may not be utilized.

### Model Training

As discussed above, ML models associated with systems discussed above with respect to FIGS. 1-2 may be trained, validated, and tested using training data sets based on one or more of real-life data (e.g., text, videos, audios), synthetic generated data by LLMs, emergency related data (e.g., injury, life-threatening medical emergencies, fires, crimes in progress, and situations involving imminent danger), and high confidence data. In some instances, the training data sets may be based on data collected during detection conducted on a user device. To protect user privacy, the data ML model training and training data generation may include differential privacy and/or federated learning. Additionally or alternatively, any data collected during detection on a user device may be encrypted. The ML models may include the ML models associated with the detection model at block 108, the first detection model at block 214, and the second detection model at block 208.

In some instances, when the detection model is a scam detection model, the distribution of data labeled as a scam may be less than the data labeled as normal across training, validating, and/or testing. In one example, the percentage of data labeled as scam may be approximately 3% of the total training data (or more or less than 3%) during each of training, validating, and/or testing.

The ML models may be trained on one or more server computing devices (e.g., server computing device(s) 1002). Following training of the ML models using training data sets (e.g., data sets generated by the training data generation module 300), the ML models may be quantized and distributed to user devices for use in detection. The quantization may include reducing the size of the ML models for storage on user devices.

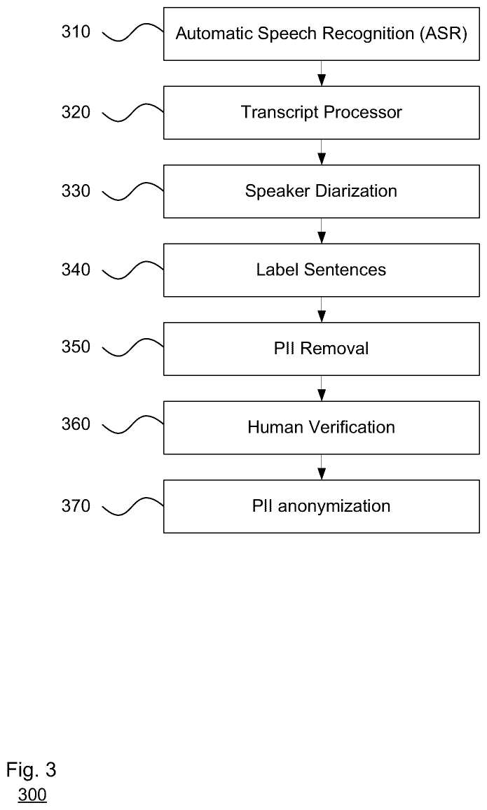

FIG. 3 illustrates an example flow of a training data generation module 300. The training data generation module 300 may be configured to input data to use in the generation of training data. The one or more sources may include real-life data (e.g., text, videos, audios),, synthetic generated data by LLMs, emergency related data, and/or high confidence data.

The training data generation module 300 includes an ASR model 310. The ASR model 310 may be configured to transcribe the audio of the input data into a format usable by the transcript processor 320. In some instances, when the input data includes audio, the ASR model 310 may provide timestamps of when words are spoken within the audio data. In some instances, the timestamps may include both start and end timestamps of when each word is spoken.

The training data generation module 300 includes a transcript processor 320. In some instances, the transcript processors may be an LLM. The transcript processor may be configured to clean the transcripts including transcribed audio from the ASR model 310 and text input data. The cleaning may include correction of grammatical, spelling, and other errors within the transcript. The transcript processor 320 may be further configured to “chunk” transcripts into discrete portions. For example, the chunking may include dividing the transcript into N portions of similar size. The portions or chucks may be a predetermined length. In some instances, the chunks may be a number of words (e.g., 100, 200, 300, or more or less). Additionally or alternatively, the chunks may be a number of sentences (e.g., 1 sentence, 2 sentences, etc.). Additionally or alternatively, the chunks may include text associated with a single speaker. In this context, the term speaker may refer to the entity that is communicating by verbal or written means.

The training data generation module 300 may include a speaker diarization module 330. The speaker diarization module 330 may be an LLM and be configured to provide each chunk or portion of the transcript with a label of who is speaking (e.g., scammer, victim).

The training data generation module 300 includes a labeling module 340. The labeling module 340 may be an LLM and be configured to label a chunk or portion of the transcript with a label indicative of if the communication is of a particular category (e.g., scam or not scam). The label may be associated with the data input as a whole. In this regard, when the particular category includes scam communication, portions spoken by both a scammer and victim may be labeled as scam.

The training data generation module 300 includes a personally identifiable information (PII) removal module 350. The PII removal module 350 may be configured to remove PII from the data set. The PII to be removed may be names, addresses, banking information, etc. In some instances, the PII removal module 350 may be configured to detect and replace PII (e.g., name, address, date, phone number etc.) with generic expressions or masked words (e.g., PII_NAME, PII_ADDRESS, PII_DATE, PII_PHONENUMBER, etc.).

The training data generation module 300 includes a human verification module 360. In the human verification module 360, the entire data set, including chunks or portions labeled by speaker and by for example, scam or not scam is verified by human annotators. Additionally, the human annotators may remove any remaining PII. In some instances, the human verification module 360 may be optional.

The training data generation module 300 includes a PII anonymization module 370. The PII anonymization module 370 may be configured to input randomized PII into the data set. For example, the PII anonymization module may add randomized names, addresses, banking information, etc. into the data set at locations where real PII was previously located. In some instances, the PII anonymization module 370 may be an LLM.

In some instances, the training data generation module 300 may further include a noise generation module. The noise generation module may be configured to augment data to provide noise. The augmentation may include adding or removing words from the training data. The augmentation may result in one or more complex training data sets.

### Example Devices

The following discusses examples of user computing devices which may be used in conjunction with the technology presented herein. These examples are not intended to limit the scope of the technology.

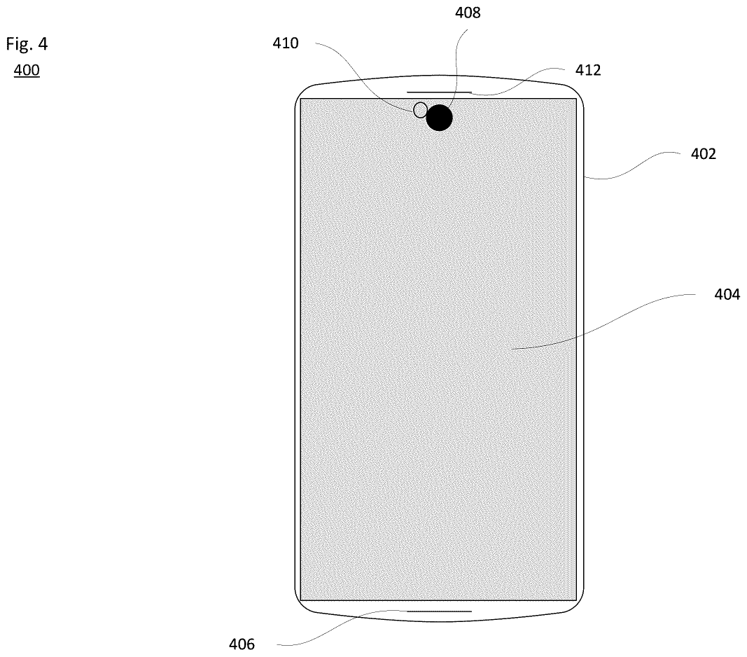

The systems and methods discussed herein may include one or more client computing devices. FIG. 4 illustrates an example 400 of a client computing device 400. The example including a handheld-type client mobile device 402, such as a smartphone or personal digital assistant (PDA), etc. In this example, client mobile device 402 includes a display 404, a microphone 406, an integrated camera 408, an indicator 410, and a speaker 412.

The display 404 may be configured to visually present content. The display 404 may also be configured as a user input (e.g., a touchscreen). Microphone 406 may be used for capturing audio, phone calls, audio for a videoconference, etc. In this regard, microphone 406 may be configured as an audio user input. The integrated camera 408 can be used for capturing photos, videoconferences, interactive gaming, etc. In this regard, the integrated camera 408 may be configured as a visual user input. Indicator 410, such as an LED, may be configured to illuminate when the integrated camera 408 is in use to alert a user that the integrated camera 408 is in use. Speaker 412 may be configured to output audio to the user. The audio may be related to phone calls, videoconferences, videos, etc.

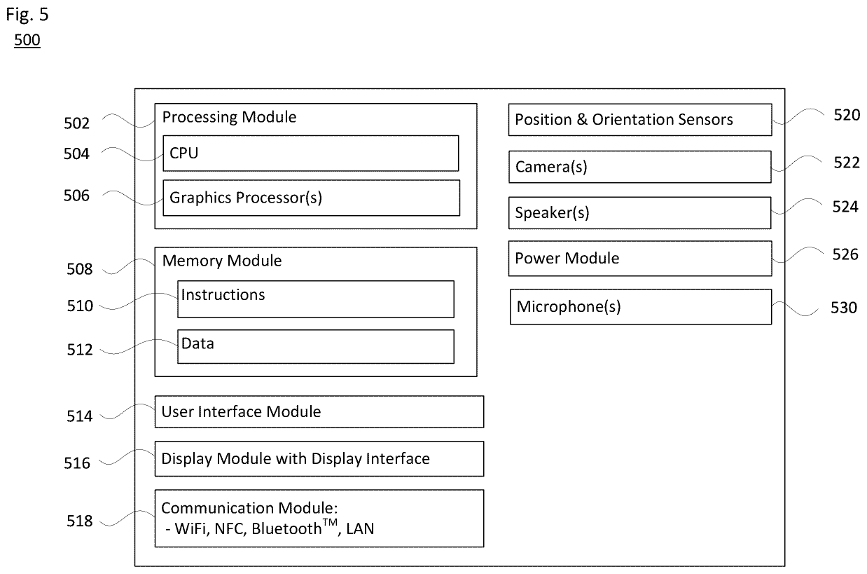

FIG. 5 illustrates a block diagram of an example handheld client mobile device 500, such as the smartphone shown in FIG. 4. As shown, the client mobile device 500 includes a processing module 502 having one or more processors such as a central processing unit 504 and/or graphics processors 506, as well as memory module 508 configured to store instructions 510 and data 512. The processors may or may not operate in parallel, and may include ASICs, controllers, and other types of hardware circuitry. The processors are configured to receive information from a user through user interface module 514, and to present information to the user on one or more display devices of the display module 516 having a display interface. The processing module 502 can include or otherwise implement the to implement the transcript processor, the detection module, the first detection module, and/or the second detection module discussed above with respect to FIGS. 1-2.

User interface module 514 may receive commands or other input information from a user via user inputs and convert them for submission to a given processor. The user interface module may link to a web browser and other applications executed by the client mobile device's processing module 502. The user inputs may include one or more of a touchscreen, stylus, microphone, or other types of input devices. The display module 516 may comprise appropriate circuitry for driving the display device to present graphical and other information to the user. By way of example, the graphical information may be generated by the graphics processor(s) 506, while CPU 504 manages overall operation of the client mobile device 500. The graphical information may display responses to user queries on the display module 516. For instance, the processing module may run an application or other service using instructions and data stored in memory module 508, and present information associated with the application or other service to the user via the display module 516. The memory module may include a database or other storage for application-related information, etc.

Memory module 508 can be implemented as one or more of a computer-readable medium or media, a volatile memory unit or units, or a non-volatile memory unit or units. The memory module 508 may include, for example, flash memory and/or NVRAM, and may be embodied as a hard-drive or memory card. One or more regions of the memory module 508 may be write-capable while other regions may comprise read-only (or otherwise write-protected) memories. Memory module 508 may store one or more systems used in detection of a communication of a particular category discussed in more detail below.

The data 512 may be retrieved, stored, or modified by the processors in accordance with the instructions 510. For instance, the data may be stored in computing device registers, in a relational database as a table having a plurality of different fields and records, XML documents or flat files. The data may also be formatted in any computing device-readable format.

The instructions 510 may be any set of instructions to be executed directly (such as machine code) or indirectly (such as scripts) by the processor(s). For example, the instructions may be stored as mobile device code on the mobile device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 5, the client mobile device 500 includes a communication module 518 for communicating with other devices and systems, including other client devices, servers, and databases. The communication module 518 includes a wireless transceiver. Such communication may be by one or more of email, telephone, videoconferencing, text messaging services, etc. In this regard, the client device 500 may communicate with other remote devices via the communication module 518 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, WiFi, and HTTP, and combinations of the foregoing.

The example client device 500 as shown also includes one or more position and orientation sensors 520. The position and orientation sensors 520 are configured to determine the position and orientation of one or more parts of the client mobile device 500. For example, these components may include a GPS receiver or other global positioning component to determine the device's latitude, longitude and/or altitude as well as an accelerometer, gyroscope or another direction/speed detection device such as an inertial measurement unit (IMU). The mobile device 500 may also include one or more camera(s) 522 for capturing still images, recording video streams, etc. such as the integrated camera as discussed above. In this regard, the one or more cameras(s) 522 may be configured as a visual user input. The mobile device 500 may further include speaker(s) 524. Speaker(s) 542 may be configured to output audio to the user. Power module 526 provides power to the various system components. The mobile device 500 may further include a microphone 530, which may comprise a microphone array having one or more transducers or other microphone elements distributed at various points along the housing of the computing device. The microphone 530 may be configured as an audio user input.

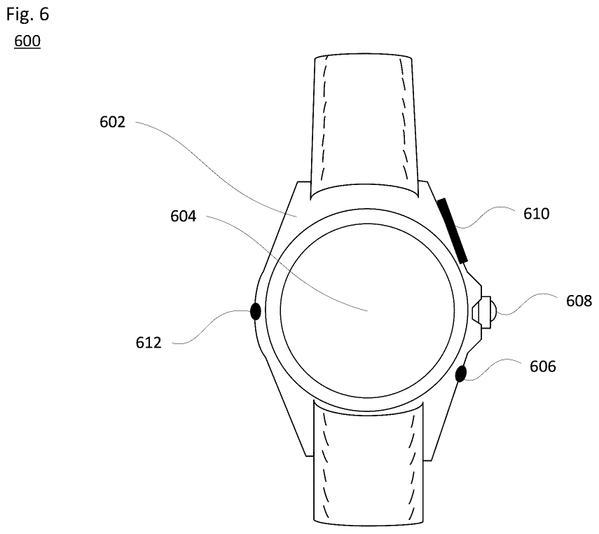

FIG. 6 illustrates an example 600 showing a wearable-type client device 602, such as a smartwatch. In this example, wearable client device 602 includes a display 604, a microphone 606, crown 608, button 610, and speaker 612. The display 604 may be configured to visually present content. The display 604 may also be configured as a user input (e.g., a touchscreen). Microphone 606 may be used for capturing audio, phone calls, etc. In this regard, microphone 606 may be configured as an audio user input. The crown 608 may be configured as a user input. In this regard, crown 608 may be used by a user for navigation through the features of the wearable client device 602. For example, the crown 608 may be configured to be turned by a user. The turning may allow the user to scroll through features or content presented on the display 604 and interact with the features or content (e.g., zoom, make selections, etc.). In some instances, the crown may be a knob. Button 610 may be configured as a user input. In this regard, a user may press button 610 to interact with the features or content (e.g., zoom, make selections, etc.). Speaker 612 may be configured to output audio to the user. The audio may be related to phone calls, videoconferences, videos, etc.

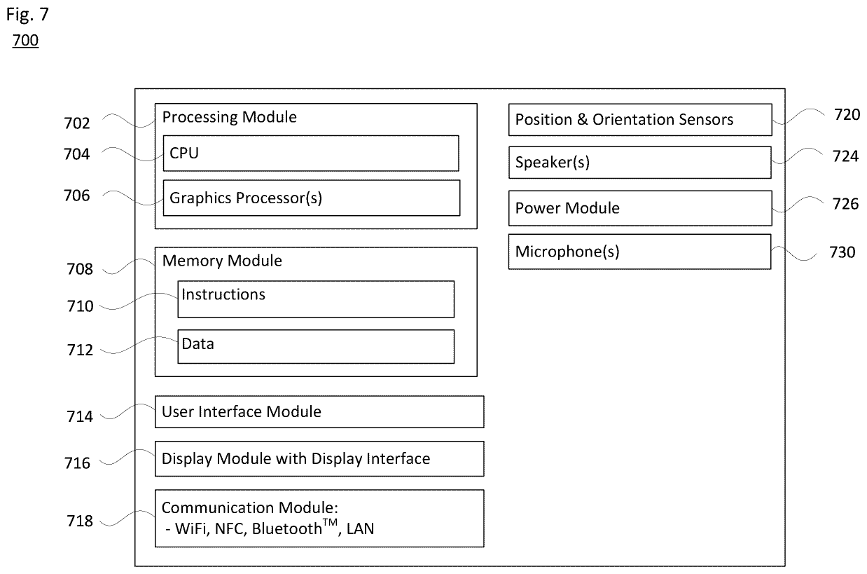

FIG. 7 illustrates a block diagram of an example wearable client device 700, such as the smartwatch shown in FIG. 6. As shown, the wearable client device 700 includes a processing module 702 having one or more processors such as a central processing unit 704 and/or graphics processors 706, memory module 708 configured to store instructions 710 and data 712, user interface module 714, display module 716 having a display interface, communication module 718, one or more position and orientation sensors 720, one or more speakers 724, power module 726, and one or more microphones 730. The processing module 702, the central processing unit 704, the graphics processors 706, the memory module 708, the instructions 710, the data 712, the user interface module 714, the display module 716, the communication module 718, the one or more position and orientation sensors 720, the one or more speakers 724, the power module 726, and the one or more microphones 730 may be configured in the same or similar manner as the processing module 502, the central processing unit 504, the graphics processors 506, the memory module 508, the instructions 510, the data 512, the user interface module 514, the display module 516, the communication module 518, the one or more position and orientation sensors 520, the one or more speakers 524, the power module 526, and the one or more microphones 530 respectively.

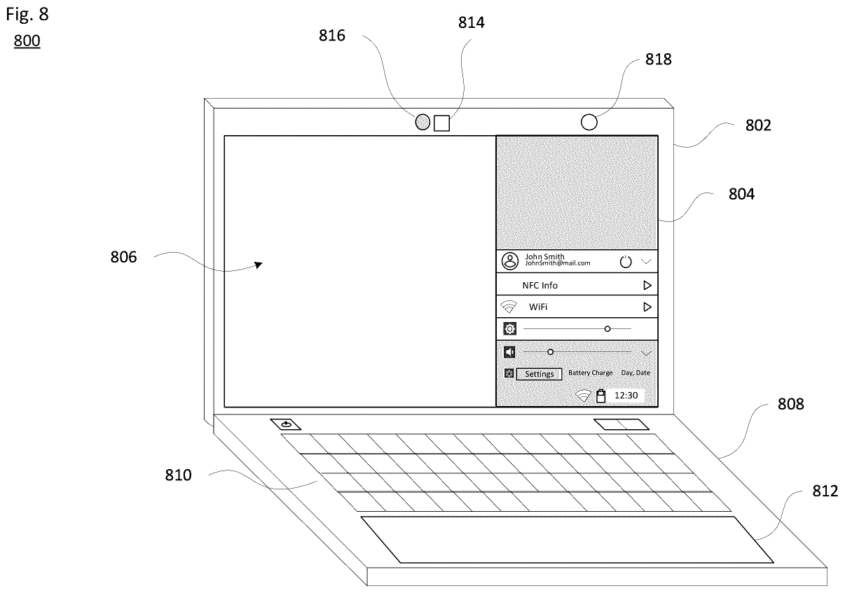

FIG. 8 illustrates an example 800 showing a client computing device 802, such as a laptop computer. In this example, there is a display 804 for visually presenting content via graphical user interface (GUI) 806, and a user input section 808 having a keyboard 810 and a trackpad 812 as different user inputs. The display 804 may be configured as a user input (e.g., a touchscreen). The keyboard 810 may be a virtual keyboard, for instance as part of another display. While one trackpad 812 is shown, the device may have two or more trackpads arranged thereon. The device may contain additional user inputs (e.g., a mouse, audio and/or gesture-based inputs).

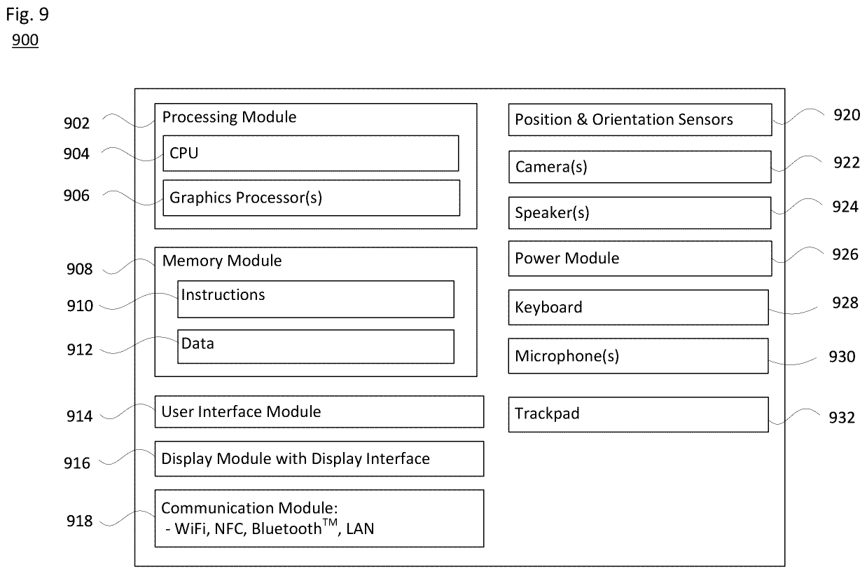

An integrated webcam 814 can be used for videoconferences, interactive gaming, etc. Indicator 816, which may be an LED, may be illuminated to alert a user whenever the integrated webcam 814 is in use. The client computing device 802 may include a microphone (not shown) may be provided as an audio input for phone calls, videoconferences, etc. In some instances, the microphone may be included in integrated webcam 814. The client computing device 802 may further include one or more speakers (not shown). The one or more speakers may be configured to output audio to the user. The audio may be related to phone calls, videoconferences, videos, etc. In some instances, the one or more speakers may be included in integrated webcam 814. The client computing device 802 may also include one or more other sensors 818, which may be used to supplement visual information obtained by the webcam 814. By way of example, the one or more other sensors may include an additional imaging device, an RF or ultrasonic-based motion sensor, such as to help identify gestures by the user or act as a human presence detector. FIG. 9 illustrates a block diagram of an example client computing device 900, such as the laptop shown in FIG. 8 (e.g., a tablet PC or netbook), a desktop PC, an in-home device such as a smart display, or the like. As shown, the client computing device 900 includes a processing module 902 having one or more processors such as a central processing unit 904 and/or graphics processors 906, memory module 908 configured to store instructions 910 and data 912, user interface module 914, display module 916 having a display interface, communication module 918, one or more position and orientation sensors 920, one or more cameras 922, one or more speakers 924, power module 926, keyboard 928, and one or more microphones 930 and trackpad 932. The processing module 902, the central processing unit 904, the graphics processors 906, the memory module 908, the instructions 910, the data 912, the user interface module 914, the display module 916, the communication module 918, the one or more position and orientation sensors 920, the one or more cameras 922, the one or more speakers 924, the power module 926, and the one or more microphones 930 may be configured in the same or similar manner as the processing module 502, 702, the central processing unit 504, 704, the graphics processors 506, 706, the memory module 508,708 the instructions 510, 710, the data 512, 712, the user interface module 514, 714, the display module 516, 716, the communication module 518, 718, the one or more position and orientation sensors 520, 720, the one or more cameras 522, the one or more speakers 524, 724, the power module 526, 726, and the one or more microphones 530, 730, respectively. Additionally, keyboard 928 and trackpad 932 may be configured as user inputs of the client computing device 900. Trackpad 932 may include either a capacitive touch sensor unit or a piezoelectric sensor unit (or both).

### Example Networks

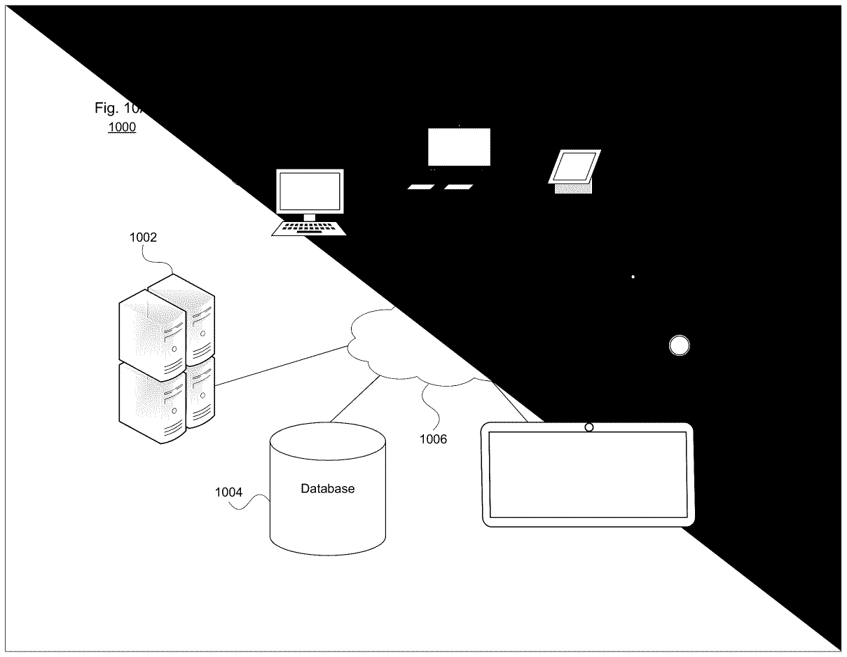

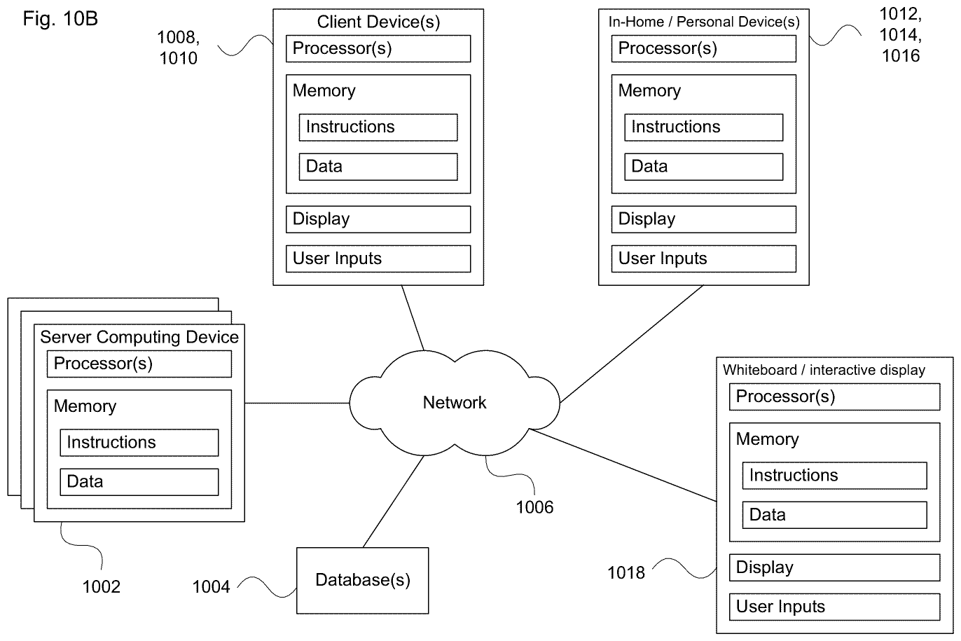

One or more devices, such as the devices discussed above with reference to FIGS. 4-9, may connect to one another over a network. FIGS. 10A and 10B are pictorial and functional diagrams, respectively, of an example system 1000 that includes a plurality of computing devices and databases connected via a network. For instance, computing device(s) 1002 may be a cloud-based server system that provides or otherwise supports one or more apps, games, or other programs. Database 1004 may store messaging app information, game data, user profile information, and/or other information. The server system may access the databases via network 1006. Client devices may include one or more of a desktop computer 1008, a laptop or tablet PC 1010 and in-home devices such as smart display 1012. Other client devices may include a personal communication device such as a mobile phone or PDA 1014 or a wearable device 1016 such as a smartwatch, etc. Another example client device is a large screen display or interactive whiteboard 1018, such as might be used in a classroom, conference room, auditorium or other collaborative gathering space where multiple users may be present. An additional client device may be a pair of headphones or earbuds (not shown).

In one example, computing device 1002 may include one or more server computing devices having a plurality of computing devices, e.g., a load balanced server farm or cloud computing system, that exchange information with different nodes of a network for the purpose of receiving, processing, and transmitting the data to and from other computing devices. For instance, computing device 1002 may include one or more server computing devices that are capable of communicating with any of the computing devices 1008-1018 via the network 1006. This may be done as part of hosting one or more collaborative apps (e.g., a video conferencing program, an interactive spreadsheet app or a multiplayer game) or services (e.g., a movie streaming service or interactive game show where viewers can provide comments or other feedback).

As shown in FIG. 10B, each of the computing devices 1002 and 1008-1018 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 10B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 1002. Accordingly, references to a processor or computing device will be understood to include references to a collection of processors or computing devices or memories that may or may not operate in parallel.

Moreover, reference to “one or more processors” herein includes situations where a set of processors may be configured to perform one or more operations. Any combination of such a set of processors may perform individual operations or a group of operations. This may include two or more CPUs, GPUs and/or TPUs (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touchscreen and/or microphone) and one or more display devices that operable to display information (e.g., text, imagery and/or other graphical elements). Other output devices, such as speaker(s) may also provide information to users.

The user-related computing devices (e.g., 1008-1018) may communicate with a back-end computing system (e.g., server 1002) via one or more networks, such as network 1006. The network 1006, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi, and HTTP, and various combinations of the foregoing. Such communication may be facilitated by any device capable of transmitting data to and from other computing devices, such as modems and wireless interfaces.

In some implementations, the user-related computing devices may also communicate with one another without also communicating with a back-end computing system. For example, FIG. 11 illustrates a system 1100 where a client mobile device 1102 (e.g., a smartphone or PDA) and a wearable client device 1104 (e.g., a smartwatch) are wirelessly connected via a network 1106. The client mobile device 1102 may be the client mobile device discussed with regard to FIGS. 2-5. Similarly, the wearable client device 1104 may be the client wearable device discussed with regard to FIGS. 6-7. The network 1106, and intervening nodes, may include the same configuration as network 1006. Alternatively or additionally, the network 1106 may comprise one or more ad hoc and/or peer to peer communication links between the devices 1102 and 1104. Here, there would be no intervening nodes.

### Example Methods

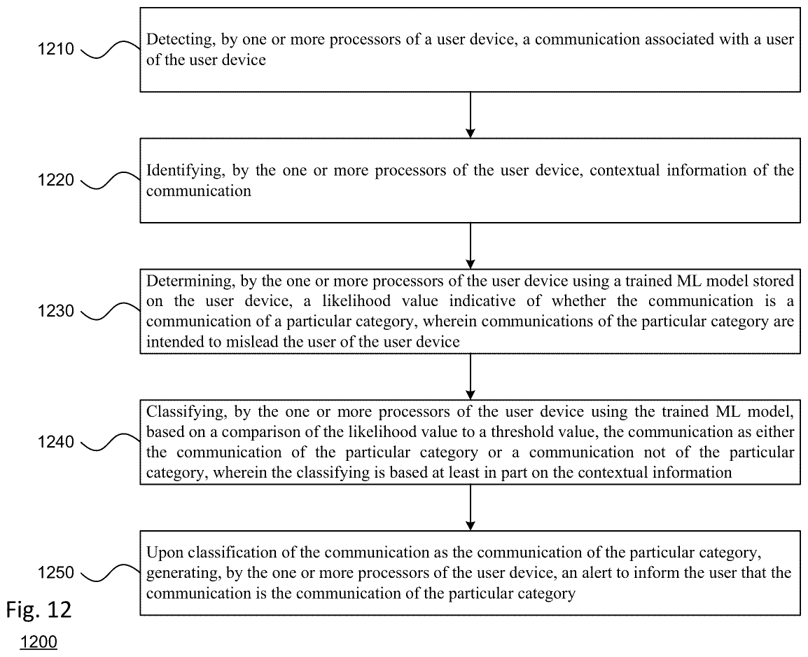

The systems described above may be used in methods of detection of a communication of a particular category (e.g. scam detection). FIG. 12 illustrates an example method 1200 of a communication of a particular category. The example method 1200 may be performed by a user device (e.g., client mobile device 402, client mobile device 500, wearable client device 602, wearable client device 700, client computing device 802, client computing device 900). In this regard, the method 1200 may be used in a system as discussed above with respect to FIG. 1. At block 1210, the method includes detecting, by one or more processors of a user device, a communication associated with a user of the user device. In this regard, a user device may employ a system for detection of a communication of a particular category such as the system discussed above with respect to FIG. 1. Such a system may be configured to detect communications as discussed above with respect to FIG. 1. In some instances, the method may further include transcribing the communication using the ASR model as discussed above. Additionally, or alternatively, the method may include processing the transcript by dividing the transcript into N portions as discussed above using a transcript processor.

At block 1220, the method further includes identifying, by the one or more processors of the user device, contextual information of the communication. In this regard, the one or more processors of the user device may identify the contextual information. In some instances, the one or more processors may utilize one or more sensors of the user device to identify contextual information. As discussed above, the context may include information such as environmental information of the remote device and the client device (e.g., location, ambient noise), opening of an application (e.g., banking application) during or immediately after (e.g., within 1 minute, 10 minutes, or more or less) the communication, screen sharing of the user device during the communication, installing a new application to the user device during or immediately after the communication, allowing for remote control of the user device during the communication, knowledge base of known contacts (e.g., whether the remote device is associated with a saved contact or is an unknown), physiological signals of the user of the user device (e.g., heart rate, skin conductance). In some instances, the context may be identified or collected both by the user device and a second user device. In this regard, the contextual information may be additionally identified by the one or more processors of the second user device and communicated to the one or more processors of the user device. The one or more processors of the second user device may utilize one or more sensors thereof to identify contextual information.

At block 1230, the method further includes determining, by the one or more processors of the user device using a trained ML model stored on the user device, a likelihood value indicative of whether the communication is a communication of a particular category, wherein communications of a particular category are intended to mislead the user of the user device. In this regard, the trained ML model may determine a likelihood value regarding whether or not the communication is a particular category based on an analysis of the communication. The ML model may determine the likelihood value as discussed above with respect to the detection model of FIG. 1. In some instances, the context may be analyzed by the ML model resulting in an increase or decrease of the likelihood value. Additionally or alternatively, the context may increase or decrease the threshold value to which the likelihood value is compared.

In some instances, a combination of context information may be analyzed in the increase or decrease of the likelihood and/or increase or decrease of the threshold value. When the particular category includes scam communications, certain combinations of contextual information may be indicative of a high probability of a scam and thus be given more weight than when observed in combination. For example, if a user of the user device both downloads an application during the communication and screenshares during the communication, such behavior is highly indicative of a scam and should be given more weight. Being given more weight may include the threshold value for outputting a scam result being decreased.

At block 1240, the method further includes classifying, by the one or more processors of the user device using the trained ML model, based on a comparison of the likelihood value to a threshold value, the communication as either the communication of the particular category or a communication not of the particular category, wherein the classifying is based at least in part on the contextual information. In this regard, if the likelihood is above a threshold value, the trained ML model may output a result indicative that the communication is of the particular category (e.g. scam result). Alternatively, if the likelihood is below the threshold value, the trained ML model may output a normal result. As discussed above with respect to FIG. 1, the trained ML model may further base the classification on context information associated with the communication.

At block 1250, the method further includes, upon classification of the communication as the communication of the particular category, generating, by the one or more processors of the user device, an alert to inform the user that the communication is of the particular category. As discussed above with respect to FIG. 1, the alerts to the user may include, visual, text, audio, and or haptic alerts to signal to the user that the communication is of the particular category. The alerts may be presented to the user by the user device. The alerts may also be a prompt asking a user if they want to take a particular action. For example, when a scam is detected and a user attempts to open a sensitive application (e.g., banking application). The prompt may display text such as, “Are you sure? Possible Scam.” In some instances, the method may further include initiating additional harm mitigation strategies such as those discussed above with respect to FIG. 1.

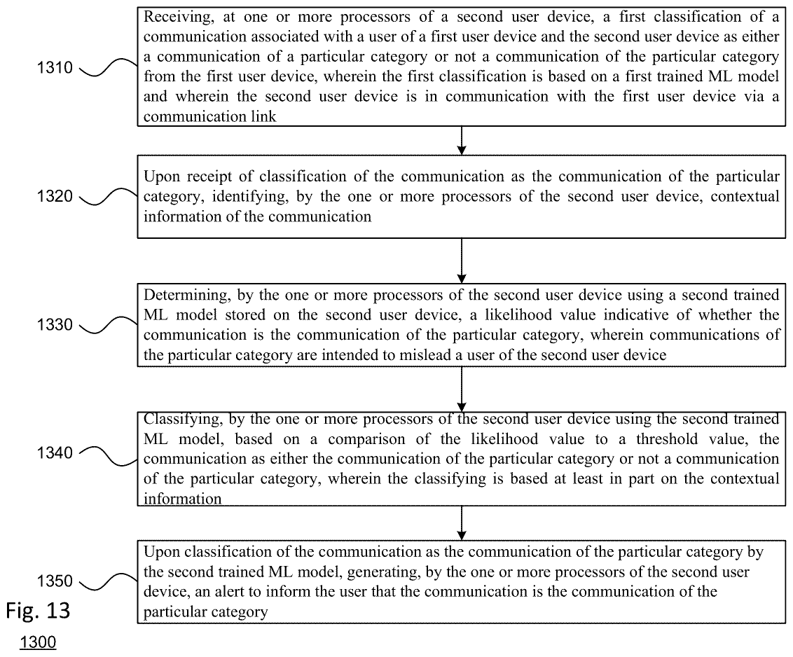

FIG. 13 illustrates an example method 1300 of detection of a communication of a particular category (e.g. scam detection). The example method 1300 may be performed by a second user device (e.g., client mobile device 402, client mobile device 500, client computing device 802, client computing device 900). In this regard, the method 1300 may be used in a system including a first client device and a second client device as discussed above with respect to FIG. 2 At block 1310, the method includes receiving, at one or more processors of a second user device, a first classification of a communication associated with a user of a first user device and the second user device as either a communication of a particular category or not a communication of the particular category from the first user device, wherein the first classification is based on a first trained ML model and wherein the second user device is in communication with the first user device via a communication link. In this regard, a second user device may receive a classification from a first user device. The first classification may be determined as discussed above with respect to a first detection model of FIG. 2. In some instances, the first user device may be a wearable device (e.g., wearable client device 602, wearable client device 700).

At block 1320, the method further includes upon receipt of classification of the communication as the communication of the particular category communication, identifying, by the one or more processors of the second user device, contextual information of the communication. In this regard, the one or more processors of the second user device may identify the contextual information. In some instances, the one or more processors of the second may utilize one or more sensors of the second user device to identify contextual information. As discussed above, the context may include information such as environmental information of the remote device and the client device (e.g., location, ambient noise), opening of an application (e.g., banking application) during or immediately after (e.g., within 1 minute, 10 minutes, or more or less) the communication, screen sharing of the user device during the communication, installing a new application to the user device during or immediately after the communication, allowing for remote control of a user device during the communication, knowledge base of known contacts (e.g., whether the remote device is associated with a saved contact or is an unknown), physiological signals of the user of the user device (e.g., heart rate, skin conductance). In some instances, the context may be identified or collected both by the second user device and the first user device. In this regard, the contextual information may be additionally identified by the one or more processors of the first user device and communicated to the one or more processors of the second user device. The one or more processors of the first user device may utilize one or more sensors thereof to identify contextual information.

At block 1330, the method further includes determining, by the one or more processors of the second user device using a second trained ML model stored on the second user device, a likelihood value indicative of whether the communication is the communication of the particular category, wherein communications of the particular category are intended to mislead a user of the second user device. In this regard, the second trained ML model may determine a likelihood value regarding whether or not the communication is the communication of the particular category based on an analysis of the communication. The second trained ML model may determine the likelihood value as discussed above with respect to the second detection model of FIG. 2. In some instances, the context may be analyzed by the ML model resulting in an increase or decrease of the likelihood value. Additionally or alternatively, the context may increase or decrease the threshold value to which the likelihood value is compared.

In some instances, a combination of context information may be analyzed in the increase or decrease of the likelihood and/or increase or decrease of the threshold value. When the particular category includes scam communication, certain combinations of contextual information may be indicative of a high probability of a scam and thus be given more weight than when observed in combination. For example, if a user of the user device both downloads an application during the communication and screenshares during the communication, such behavior is highly indicative of a scam and should be given more weight.

At block 1340, the method further includes classifying, by the one or more processors of the second user device using the second trained ML model, based on a comparison of the likelihood value to a threshold value, the communication as either the communication of the particular category or not a communication of the particular category, wherein the classifying is based at least in part on the contextual information. In this regard, if the likelihood is above a threshold value, the second trained ML model may output a result indicative that the communication is of the particular category (e.g. scam result). Alternatively, if the likelihood is below the threshold value, the second trained ML model may output a normal result. As discussed above with respect to FIG. 2, the second trained ML model may further base the classification on context information associated with the communication.

At block 1350, the method further includes upon classification of the communication as the communication of the particular category by the second trained ML model, generating, by the one or more processors of the second user device, an alert to inform the user that the communication is the communication of the particular category. As discussed above with respect to FIG. 2, the alerts to the user may include, visual, text, audio, and or haptic alerts to signal to the user that the communication is a communication of the particular category. The alerts may be presented to the user by the second user device. The alerts may also be a prompt asking a user if they want to take a particular action. For example, when a scam is detected and a user attempts to open a sensitive application (e.g., banking application). The prompt may display text such as, “Are you sure? Possible Scam.” In some instances, the method may further include initiating additional scam mitigation strategies such as those discussed above with respect to FIG. 2.

The systems and methodology described herein provide a technical benefit of allowing for robust real-time scam detection of communications of a particular category while still maintaining user privacy. In this regard, since the determination is fully conducted on a user's device, there is minimal delay in detection. Moreover, data collected during detection need not be saved locally in a memory device or exported externally, allowing for the maintenance of user privacy. Additionally, the real-time detection of a communication of the particular category itself allows mitigation of harm caused thereby. Such harm may include financial loss and loss of personal information.

Further to the descriptions above, a user may be provided with controls allowing the user to make an election as to both if and when systems, programs, or features described herein may enable collection of user information (e.g., information about social networks, social actions, or other activities, and/or a user's profession, preferences, or current location), and if the user is sent content or communications from a server or other device. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

The following paragraphs further illustrate examples of the present technology described herein.

Example 1. A method comprising:

detecting, by one or more processors of a user device, a communication associated with a user of the user device;

identifying, by the one or more processors of the user device, contextual information of the communication;

determining, by the one or more processors of the user device using a trained machine learning (ML) model stored on the user device, a likelihood value indicative of whether the communication is a communication of a particular category, wherein communications of the particular category are intended to mislead the user of the user device;

classifying, by the one or more processors of the user device using the trained ML model, based on a comparison of the likelihood value to a threshold value, the communication as either a communication of the particular category or a communication not of the particular category, wherein the classifying is based at least in part on the contextual information; and

upon classification of the communication as the communication of the particular category, generating, by the one or more processors of the user device, an alert to inform the user that the communication is the communication of the particular category.

Example 2. The method of claim 1, wherein the determining of the likelihood value is based on the contextual information.

Example 3. The method of any of claims 1-2, further comprising modifying the threshold value based on the contextual information.

Example 4. The method of claim 3, wherein the modifying includes increasing the threshold value when the contextual information is not indicative of the particular category.

Example 5. The method of any of claims 3-4, wherein the modifying includes decreasing the threshold value when the contextual information is indicative of the particular category.

Example 6. The method of any of claims 1-5, wherein the communication is a telephonic communication.

Example 7. The method of any of claims 1-6, wherein the contextual information includes a user action during or immediately following the communication.

Example 8. The method of any of claims 1-7, wherein the trained ML model is trained, validated, and tested using at least one of i) real-life data, or ii) synthetic generated data.

Example 9. The method of any of claims 1-8, further comprising:

transcribing, by the one or more processors using an automatic speech recognition (ASR) model, the communication; and

dividing, by the one or more processors, the transcribed communication in one or more portioning of a predetermined length for analysis by the trained ML model.

Example 10. The method of any of claims 1-9, wherein the alert includes guidance to the user to prevent loss due to the communication of the particular category.

Example 11. The method of any of claims 1-10, further comprising, upon classification of the communication as the communication of the particular category and in addition to generating the alert, controlling the user device to perform an action, the action being determined based on at least one of i) the communication and ii) a user action performed during or after the communication.

Example 12. A method comprising:
receiving, at one or more processors of a second user device, a first classification of a communication associated with a user of a first user device and the second user device as either a communication of a particular category or not a communication of the particular category from the first user device, wherein the first classification is based on a first trained machine learning (ML) model and wherein the second user device is in communication with the first user device via a communication link;
upon receipt of classification of the communication as a communication of the particular category, identifying, by the one or more processors of the second user device, contextual information of the communication;
determining, by the one or more processors of the second user device using a second trained ML model stored on the second user device, a likelihood value indicative of whether the communication is the communication of the particular category, wherein communications of the particular category are intended to mislead a user of the second user device;
classifying, by the one or more processors of the second user device using the second trained ML model, based on a comparison of the likelihood value to a threshold value, the communication as either the communication of the particular category or not a communication of the particular category, wherein the classifying is based on at least in part the contextual information; and
upon classification of the communication as the communication of the particular category by the second trained ML model, generating, by the one or more processors of the second user device, an alert to inform the user that the communication is the communication of the particular category.

Example 13. The method of claim 12, wherein the determining of the likelihood value is based on the contextual information.

Example 14. A user device comprising:
a memory including a trained machine learning (ML) model stored therein; and
one or more processors operatively connected to the memory, the one or more processors configured to:
   detect a communication associated with a use of the user device;
   identify contextual information of the communication;
   determine, using the trained ML model, a likelihood value indicative of whether the communication is a communication of a particular category, wherein communications of the particular category are intended to mislead a user of the user device;
   classify, using the trained ML model, based on a comparison of the likelihood value to a threshold value, the communication as either a communication of the particular category or a communication not of the particular category, wherein the classification is based at least in part on the contextual information; and
   upon classification of the communication as the communication of the particular category, generate an alert to inform the user that the communication is the communication of the particular category.

Example 15. The user device of claim 14, wherein the user device is a mobile device.

Example 16. The user device of claim 14, wherein the user device is a wearable device.

Example 17. A user device comprising:
a memory including a second trained machine learning (ML) model stored therein; and
one or more processors operatively connected to the memory, the one or more processors configured to:
   receive a first classification of a communication associated with a user of the user device and a remote user device as either a communication of the particular category or a communication not of the particular category from the remote user device, wherein the first classification is based on a first trained ML model and wherein the remote user device is in communication with the user device via a communication link;
upon receipt of classification of the communication as a communication of the particular category, identify contextual information of the communication;
determine, using the second trained ML model, a likelihood value indicative of whether the communication is the communication of the particular category, wherein communications of the particular category are intended to mislead a user of the user device;
classify, using the second trained ML model, based on a comparison of the likelihood value to a threshold value, the communication as either the communication of the particular category or the communication not of the particular category, wherein the classification is based at least in part on the contextual information; and
upon classification of the communication as the communication of the particular category by the second trained ML model, generate an alert to inform the user that the communication is the communication of the particular category.

Example 18. The user device of claim 17, wherein the user device is a mobile device.

Example 19. A non-transitory computer-readable recording medium having instructions stored thereon, the instructions, when executed by one or more processors of a user device, implement the method of any of Examples 1-11.

Example 20. A non-transitory computer-readable recording medium having instructions stored thereon, the instructions, when executed by one or more processors of a user device, implement the method of Examples 12-13.

1. A method comprising:
detecting, by one or more processors of a user device, a communication associated with a user of the user device;
identifying, by the one or more processors of the user device, contextual information of the communication;
determining, by the one or more processors of the user device using a trained machine learning (ML) model stored on the user device, a likelihood value indicative of whether the communication is a communication of a particular category, wherein communications of the particular category are intended to mislead the user of the user device;
classifying, by the one or more processors of the user device using the trained ML model, based on a comparison of the likelihood value to a threshold value, the communication as either the communication of the particular category or a communication not of the particular category, wherein the classifying is based at least in part on the contextual information; and
upon classification of the communication as the communication of the particular category, generating, by the one or more processors of the user device, an alert to inform the user that the communication is the communication of the particular category.

2. The method of claim 1, wherein the determining of the likelihood value is based on the contextual information.

3. The method of claim 1, further comprising modifying the threshold value based on the contextual information.

4. The method of claim 3, wherein the modifying includes increasing the threshold value when the contextual information is not indicative of the particular category.

5. The method of claim 3, wherein the modifying includes decreasing the threshold value when the contextual information is indicative of the particular category.

6. The method of claim 1, wherein the communication is a telephonic communication.

7. The method of claim 1, wherein the contextual information includes a user action during or immediately following the communication.

8. The method of claim 1, wherein the trained ML model is trained, validated, and tested using at least one of i) real-life data, or ii) synthetic generated data.

9. The method of claim 1, further comprising:
transcribing, by the one or more processors using an automatic speech recognition (ASR) model, the communication; and
dividing, by the one or more processors, the transcribed communication in one or more portioning of a predetermined length for analysis by the trained ML model.

10. The method of claim 1, wherein the alert includes guidance to the user to prevent loss due to the communication of the particular category.

11. The method of claim 1, further comprising, upon classification of the communication as the communication of the particular category and in addition to generating the alert, controlling the user device to perform an action, the action being determined based on at least one of i) the communication and ii) a user action performed during or after the communication.

12. A method comprising:
receiving, at one or more processors of a second user device, a first classification of a communication associated with a user of a first user device and the second user device as either a communication of a particular category or not a communication of the particular category from the first user device, wherein the first classification is based on a first trained machine learning (ML) model and wherein the second user device is in communication with the first user device via a communication link;
upon receipt of classification of the communication as the communication of the particular category, identifying, by the one or more processors of the second user device, contextual information of the communication;
determining, by the one or more processors of the second user device using a second trained ML model stored on the second user device, a likelihood value indicative of whether the communication is the communication of the particular category, wherein communications of the particular category are intended to mislead a user of the second user device;
classifying, by the one or more processors of the second user device using the second trained ML model, based on a comparison of the likelihood value to a threshold value, the communication as either the communication of the particular category or not a communication of the particular category, wherein the classifying is based on at least in part the contextual information; and
upon classification of the communication as the communication of the particular category by the second trained ML model, generating, by the one or more processors of the second user device, an alert to inform the user that the communication is the communication of the particular category.

13. The method of claim 12, wherein the determining of the likelihood value is based on the contextual information.

14. A user device comprising:
a memory including a trained machine learning (ML) model stored therein; and
one or more processors operatively connected to the memory, the one or more processors configured to:
detect a communication associated with a use of the user device;
identify contextual information of the communication;
determine, using the trained ML model, a likelihood value indicative of whether the communication is a communication of a particular category, wherein communications of the particular category are intended to mislead a user of the user device;
classify, using the trained ML model, based on a comparison of the likelihood value to a threshold value, the communication as either the communication of the particular category or a communication not of the particular category, wherein the classification is based at least in part on the contextual information; and
upon classification of the communication as the communication of the particular category, generate an alert to inform the user that the communication is the communication of the particular category.

15. The user device of claim 14, wherein the user device is a mobile device.

16. The user device of claim 14, wherein the user device is a wearable device.

17. A user device comprising:
a memory including a second trained machine learning (ML) model stored therein; and
one or more processors operatively connected to the memory, the one or more processors configured to:
receive a first classification of a communication associated with a user of the user device and a remote user device as either a communication of a particular category or a communication not of the particular category from the remote user device, wherein the first classification is based on a first trained ML model and wherein the remote user device is in communication with the user device via a communication link;
upon receipt of classification of the communication as the communication of the particular category, identify contextual information of the communication;
determine, using the second trained ML model, a likelihood value indicative of whether the communication is the communication of the particular category, wherein communications of the particular category are intended to mislead a user of the user device;
classify, using the second trained ML model, based on a comparison of the likelihood value to a threshold value, the communication as either the communication of the particular category or the communication not of the particular category, wherein the classification is based at least in part on the contextual information; and
upon classification of the communication as the communication of the particular category by the second trained ML model, generate an alert to inform the user that the communication is the communication of the particular category.

18. The user device of claim 17, wherein the user device is a mobile device.

19. A non-transitory computer-readable recording medium having instructions stored thereon, the instructions, when executed by one or more processors of a user device, implement the method of claim 1.

20. A non-transitory computer-readable recording medium having instructions stored thereon, the instructions, when executed by one or more processors of a user device, implement the method of claim 12.
